(19) United States
(12) Patent Application Publication
(10) Pub. No.: US 2026/0343487 A1
(43) Pub. Date: Oct. 29, 2026

(54) REPORTING MOVING PATH INFORMATION FOR A MOBILE INTEGRATED ACCESS AND BACKHAUL NODE

(71) Applicant: TELEFONAKTIEBOLAGET LM ERICSSON (PUBL), Stockholm (SE)

(72) Inventors: Helka-Liina Määttänen, ESPOO (FI); Antonino Orsino, KIRKKONUMMI (FI); Mattias Bergström, SOLLENTUNA (SE)

(21) Appl. No.: 19/117,223

(22) PCT Filed: Sep. 28, 2023
(86) PCT No.: PCT/IB2023/059713

§ 371 Date: Mar. 31, 2025

Related U.S. Application Data
(60) Provisional application No. 63/411,394, filed on Sep. 29, 2022.

(51) Int. Cl. H04W 64/00; H04W 4/021; H04W 76/20; H04W 84/00

(52) U.S. Cl. CPC H04W 64/006; H04W 4/021; H04W 76/20; H04W 84/005

(57) ABSTRACT

There is provided a method performed by a mobile integrated access and backhaul (IAB) node. The method comprises obtaining moving path information which indicates a moving path of the IAB node, and triggering transmission of the obtained moving path information towards a network node. The network node is either a donor IAB node or an intermediate parent IAB node.

### TECHNICAL FIELD

Disclosed are embodiments related to reporting moving path information for a mobile integrated access and backhaul (IAB) node.

### BACKGROUND

Unmanned Aerial Vehicles (UAV) communications in the 3rd Generation Partnership Project (3GPP)

The use of drones (a.k.a., UAVs) is becoming increasingly popular. There are numerous use cases of UAVs in industry, such as goods transportation and delivery, surveillance, media production, etc.

Traditionally, a UAV can only be operated by a controller within the UAV's visual line of sight (VLoS). Realizing the great potential of connecting drones beyond visual line of sight (BVLoS) via, for example, a cellular network, the 3GPP has specified multiple features in release 15 (Rel-15) of 3GPP's Long Term Evolution (LTE), aiming at improving the efficiency and robustness of terrestrial LTE networks for providing aerial connectivity services, particularly for low altitude UAVs. These features target both command-and-control traffic for flying the drone and the data (also known as payload) traffic from the drone to the cellular network.

The key features specified include: i) support for subscription-based identification; ii) height reporting when UAV crosses height threshold (the report may include height, location (3D), horizontal and vertical speed); iii) reference signal received power (RSRP) reporting per event of N cells' signal power above a threshold (the report includes RSRP/Reference Signal Received Quality (RSRQ)/location (3D)); iv) user equipment (UE) specific uplink (UL) power control; and v) flight path information provided from an UE to a base station (e.g., evolved node B (eNB). The flight path information includes network polling, a list of waypoints (3D location), and a list of time stamps if available.

### Flight Path Reporting for UAV in LTE Rel-15

3GPP Technical Specification (TS) 36.300 V17.1.0 (“TS 36.300”) section 23.17.5 states, “E-UTRAN can request a UE to report flight path information consisting of a number of waypoints defined as 3D locations as defined in TS 36.355. A UE reports up to configured number of waypoints if flight path information is available at the UE. The report can consist also time stamps per waypoint if configured in the request and if available at the UE.”

The signaling is over the Radio Resource Control (RRC) protocol, specified in 3GPP TS 36.331 V17.1.0 (“TS 36.331”). In RAN #94-e, a new work item (WI) for supporting UAV in New Radio (NR) was approved in RP-123600 and one objective is to specify flight path reporting signaling for NR over RRC. The LTE reporting is baseline for the Release 18 discussions.

A UE is assumed to receive the flight path plan from unmanned aircraft systems traffic management (UTM) or that it is preconfigured by a user before the flight and hence before a Radio Resource Control (RRC) connection is established.

### Unmanned Aircraft Systems (UAS) Traffic Management (UTM)

It is utmost important to keep airspace safe and accessible. Therefore, a system called UTM is being developed in different parts of the world to manage the traffic of the UAS (a UAS is composed of a UAV and a UAV controller used by an operator with unique credentials and identities.) According to NASA, UTM is a collaborative, automated, and federated airspace management approach that enables safe, efficient, and equitable small UAS operations at scale. The concept of UTM is being adopted and implemented by many countries and regions in the world, e.g., in the US, Europe, Japan, Australia, etc.

According to reference [1], the UTM provides many flight-related functions for UAVs and UAV operators, including, for example: 1) remote identification: enabling UAV identification; 2) operation planning: flight planning considering various aspects e.g., UAV performance, whether condition; 3) operator messaging: message exchange between operators for e.g., position and status information; 4) FAA messaging: providing on-demand, periodic, or event-triggered communications with FAA systems to meet regulatory requirements; 5) mapping: information about airspace restrictions, obstacles, and sensitive regions; 6) Conflict advisory: real-time alerting for collision avoidance.

Mobile networks can enable reliable connectivity between the UAV and its controller. Meanwhile, UTM can connect to the UAV and the UAV controller through a core network and a radio access network (RAN). An illustration of UAS-to-UTM connectivity is provided in FIG. 5.

### Integrated Access and Backhaul (IAB) Overview

Fifth Generation (5G) networks are being designed and deployed using a dense deployment of small cells in order to simultaneously serve more user equipment (UEs) with higher throughput and lower delay. However, building a completely new infrastructure from scratch costs a lot and and takes time. Deploying a wireless backhaul is then envisioned to be an economically and technically viable approach to enable flexible and dense network. This solution was standardized in 3GPP release 16 under the term, Integrated Access and Backhaul (IAB), to support wireless relaying in Next Generation RAN (NG-RAN) and has continued in release 17.

### TAB Architecture

TAB is based on centralized unit (CU)-distributed unit (DU) split, that was standardized in release 15. The CU is in charge of the radio resource control (RRC) and the packet data convergence protocol (PCDP) while the DU is in charge of the radio link control (RLC) and multiple access control (MAC). The F1 interface connects the CU and the DU. The CU-DU split facilitates separate physical CU and DU, while also allowing a single CU to be connected to multiple DUs. FIG. 6 shows the basic architecture of TAB.

In the basic architecture of TAB shown in FIG. 6, a single IAB donor is provided for connecting to the core network. The IAB donor serves three direct TAB child nodes through two collocated DUs at the donor for wireless backhauling. The center TAB node in the three direct TAB child nodes in turn serves two IAB nodes through wireless backhaul. All TAB nodes in FIG. 6 backhauls traffic both related to UEs connected to it, and other backhaul traffic from downstream TAB nodes.

As shown in FIG. 6, the main components of TAB architecture are: (1) TAB node-A node that allows wireless access to UEs while also backhauling traffic to other nodes. The TAB node comprises a DU that provides access to connected UEs. The TAB node also comprise a mobile termination (MT) that connects to other TAB nodes or donors in UL direction for backhaul; and (2) IAB Donor: A node that provides UEs an interface to the core network and wireless functionality to other IAB-nodes to backhaul their traffic to the core network.

The defining feature of IAB is the use of wireless spectrum for both access of UEs and backhauling of data through IAB donors. Thus, there needs to be a clear separation between access and backhaul resources to avoid interference between them. This separation of access and backhaul resources cannot be handled during network planning due to dynamic nature of IAB.

In release 16, IAB was standardized with basic support for multi-hop multi-path backhaul for directed acyclic graph (DAG) topology (no mesh-based topology was supported). Rel 16 also supports Quality of Service (QoS) prioritization of backhaul traffic and flexible resource usage between access and backhaul. Current discussions in release 17 are on topology enhancements for IAB with partial migration of IAB nodes for Radio Link Failure (RLF) recovery and load balancing.

The following documents provide additional information about standardized IAB work: (1) Madapatha, Charitha et al. “On Integrated Access and Backhaul Networks: Current Status and Potentials.” IEEE Open Journal of the Communications Society 1 (2020): 1374-1389; (2) 3GPP TS 38.300. Section 4.7; and (3) 3GPP TR 38.874 Study on IAB.

In release 18, it is expected that the different RAN groups will work towards enhancing functionality of IAB through, (1) focus on mobile-IAB/vehicle mounted relays (VMR) providing 5G coverage enhancement to onboard and surrounding UEs; and (2) Ssart repeaters that build on LTE-repeaters.

The initial use cases for mobile-IAB/VMR are expected to be based on 3GPP Technical Report (TR) 22.839. One of the main use cases of mobile IAB cell is to serve the UEs which are residing in the vehicle with the vehicle mounted relay-integrated access backhaul solutions. Other relevant use cases for mobile IABs involve a mobile/nomadic TAB network node mounted on a vehicle that provides extended coverage. This involves scenarios where additional coverage is required during special events like concerts, during disasters. The nomadic IAB node provides access to surrounding UEs while the backhaul traffic from the nomadic IAB node is then transmitted wirelessly either with the help of IAB donors or non-terrestrial networks (NTN). A nomadic IAB node also reduces or even eliminates signal strength loss due to vehicle penetration for UEs that are present in the vehicles.

Advantages of Mobile IAB are reducing/eliminating the vehicle penetration loss (specially at high frequency), and/or reducing/eliminating group handover

### F1 Interface

The F1 interface connects the CU to the DU in the split architecture which is also applicable to the IAB architecture. The F1 interface connects the CU from an IAB donor to IAB DU in the child IAB nodes. The F1 interface also supports control and user plane separation through F1-C and F1-U respectively.

This interface holds even during IAB mobility where an IAB node moves and connects to parent/donor IAB nodes. In such a scenario the DU present in the mobile IAB node connects to the CU present in the IAB donor.

The IAB-DU initiates a F1 setup with the IAB-CU with which it has a transport network layer (TNL) connection and the initial F1 setup is shown below from section 8.5 of TS 38.401. Once the F1 setup is completed, the IAB donor CU sends a GNB-CU CONFIGURATION UPDATE to optionally indicate the DU cells to be activated.

### Mobile IAB

In most use cases, mobile IAB is expected to be mounted on public transport vehicles and to move in a pre-determined route by a large extent. FIG. 7 shows a mobile IAB mounted on a bus travelling on a route that is covered by 4 different stationary parent IAB nodes 1, 2, 3, and 4. The parent nodes backhaul their traffic through 2 donor nodes (donor IAB X and donor IAB Y).

The IAB node comprises a DU that provides access to UEs around it and an MT that provides a backhaul connection between the IAB node, and its parent(s) and the rest of the network. The parent IAB nodes comprise DUs that provide access to UEs and the mobile IAB(s) present in their coverage. The parent IAB nodes may also comprise MTs that backhaul its traffic together with traffic from the mobile IAB nodes. The donor nodes comprise DUs that provides access to UEs and CUs that are connected to the core network. The CUs in both donor nodes maintain a F1 connection to the IAB parent nodes under the donor nodes.

The mobile IAB node maintains an F1 connection to the donor (one donor at a time). In FIG. 7, the mobile IAB node connects to the following nodes in the different positions as described below: (1) Position A: BH through parent node 1, F1 connection to donor node IAB X; (2) Position B: BH through parent node 2, F1 connection to donor node IAB X; (3) Position C: BH through parent node 3, F1 connection to donor node IAB Y; (4) Position D: BH through parent node 4, F1 connection to donor node IAB Y. When the mobile IAB node moves from position B to position C, the mobile IAB node must change the F1 connection from the donor node IAB X to the donor node IAB Y, requiring a F1 handover and setup of backhaul RCL channels.

### SUMMARY

Certain challenges presently exist. For instance, while flight path reporting over RRC was discussed in UAS related WIs, the existing solution is directed to handling flight path reporting for UEs. However, as discussed above, there may be a scenario that a mobile IAB itself is an UAS, and the existing solution does not address how to handle flight path reporting for such mobile IAB (e.g., how an IAB node can transmit flight path information to other network nodes when there are both F1 connection and RRC connection between the IAB node and the network).

Accordingly, in one aspect there is provided a method performed by a mobile integrated access and backhaul, TAB, node. The method comprises obtaining moving path information which indicates a moving path of the TAB node; and triggering transmission of the obtained moving path information towards a network node. The network node is either a donor IAB node or an intermediate parent IAB node.

In a different aspect, there is provided a method performed by a network node. The method comprises receiving moving path information which indicates a moving path of a mobile integrated access and backhaul, TAB, node. The moving path information was transmitted by the mobile TAB node or a server, and the network node is either a donor TAB node or an intermediate parent TAB node.

In a different aspect, there is provided a computer program comprising instructions which when executed by processing circuitry of a mobile TAB node or a network node causes the mobile TAB node or the network node to perform the method of any one of the embodiments above.

In a different aspect, there is provided a carrier containing the computer program of the above embodiment, wherein the carrier is one of an electronic signal, an optical signal, a radio signal, and a computer readable storage medium.

In a different aspect, there is provided a mobile integrated access and backhaul, IAB, node. The mobile IAB node is configured to: obtain moving path information which indicates a moving path of the IAB node; and trigger transmission of the obtained moving path information towards a network node. The network node is either a donor IAB node or an intermediate parent IAB node.

In a different aspect, there is provided a network node. The network node is configured to: receive moving path information which indicates a moving path of a mobile integrated access and backhaul, IAB, node, wherein the moving path information was transmitted by the mobile IAB node or a server, and the network node is either a donor IAB node or an intermediate parent IAB node.

In a different aspect, there is provided an apparatus comprising: a processing circuitry and a memory, said memory containing instructions executable by said processing circuitry, whereby the apparatus is operative to perform the method of any one of the embodiments described above.

An advantage of the embodiments disclosed herein is that the embodiments allow a mobile IAB node to share its moving path information with other network nodes.

### BRIEF DESCRIPTION OF THE DRAWINGS

The accompanying drawings, which are incorporated herein and form part of the specification, illustrate various embodiments.

FIG. 1 shows a system according to an embodiment.

FIG. 2 shows a process according to an embodiment.

FIG. 3 shows a process according to an embodiment.

FIG. 4 shows an apparatus according to an embodiment.

FIG. 5 shows an illustration of UAS-to-UTM connectivity.

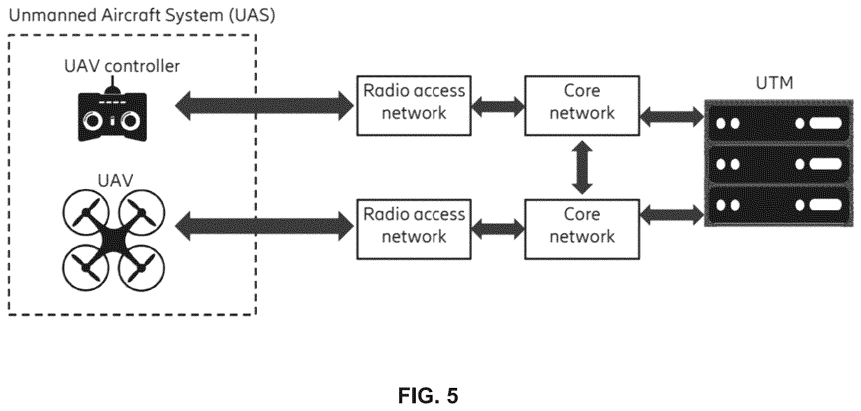

FIG. 6 shows a basic architecture of IAB.

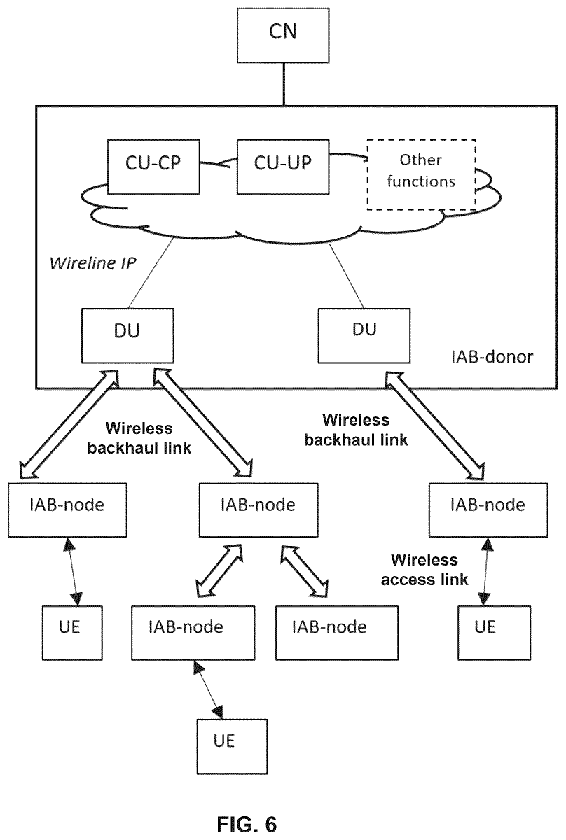

FIG. 7 shows a scenario related to a mobile IAB.

### DETAILED DESCRIPTION

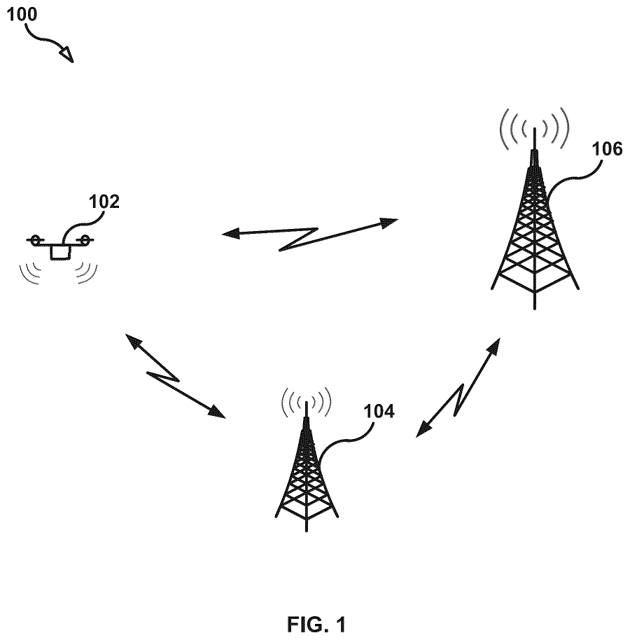

FIG. 1 shows a part of a system 100 according to some embodiments. System 100 may comprise a mobile IAB node 102, an intermediate parent IAB node 104, a donor IAB node 106, a network 112, and a user equipment (UE) 108 (e.g., a mobile phone, a tablet, a laptop, a portable computing device, etc.).

Mobile IAB node 102 is an IAB node that is moveable. For example, mobile IAB node 102 may be a portable IAB node that can be installed in or mounted on an UAV, a bus, or other moving entity. In another example, mobile IAB node 102 itself is an UAV, a bus, or other moving entity. Mobile IAB node 102 may be configured to provide a wireless network for UE 108.

Mobile IAB node 102 may be connected to network 112 via donor IAB node 106. Additionally or alternatively, mobile IAB node 102 may be connected to network 112 via intermediate parent IAB node 104 and donor IAB node 106. Intermediate parent IAB node 104 is an IAB node which serves at least one child IAB node such as mobile IAB node 102 but which is not a donor IAB node.

As discussed above, the existing solution does not address how mobile IAB node 102 can report to other network node(s) moving path information indicating a moving path of mobile IAB node 102. Note that, in case mobile IAB node 102 is an UAV, its moving path corresponds to a flight path while, in case mobile IAB node 102 is a bus, its moving path corresponds a ground route.

Embodiments of this disclosure provide solutions for allowing the 3GPP system (e.g., NR or LTE) to share moving path plan (a.k.a., moving path information) of mobile IAB node 102 with other network node(s) (e.g., access and mobility management function (AMF) of the core network, intermediate parent IAB node 104, donor IAB node 106, etc.).

In some embodiments, a DU part of mobile IAB node 102 may transmit towards a CU part of donor TAB node 106 moving path information which indicates a moving path of mobile IAB node 102 when mobile IAB node 102 establishes an F1 connection with donor IAB node 106. For example, mobile IAB node 102 may transmit towards donor IAB node 106 an F1 application protocol, F1AP, message including the moving path information. The DU part of mobile IAB node 102 may always share by default the moving path information with donor IAB node 106 or may share the moving path information with donor IAB node 106 upon receiving an explicit reporting request from donor IAB node 106.

In some embodiments, the moving path information may contain one or more of (1) a list of waypoints mobile IAB node 102 will pass and/or has passed, (2) a list of time stamps indicating timings at which mobile IAB node 102 will pass and/or has passed the waypoints, (3) a list of donor IAB nodes (donor CUs) the DU part of mobile IAB node 102 will be connected to and/or has connected to, (4) a list of intermediate parent IAB nodes the MT part of mobile IAB node 102 will be connected to and/or has connected to, (6) a list of one or more physical cell IDs, PCIs, identifying cells to which the IAB node will correspond or has corresponded; (7) a list of one or more mobility-related parameters for calculating the moving path of the IAB node; (8) a list of one or more arriving stations and/or one or more arriving points of interest, POIs in which the IAB node will arrive and/or has arrived; or (9) a list of one or more time stamps indicating timings at which the IAB node will arrive or has arrived in said one or more arriving stations (e.g., when mobile IAB node 102 is used for public transportation) and/or said one or more arriving POIs.

The mobility-related parameters may include one or more of: a set of one or more speed values each indicating a speed at which the IAB node will move and/or has moved; a set of one or more acceleration values each indicating an acceleration at which the TAB node will move and/or has moved; or a set of one or more angles each indicating a change of a moving direction of the IAB node.

In some embodiments, an MT part of mobile IAB node 102 may share the moving path information with a DU part of donor IAB node 106 or a DU part of intermediate parent IAB node 104 via RRC when establishing an RRC connection with a DU part of its parent IAB node (i.e., either intermediate parent IAB node 104 or donor IAB node 106). The MT part of mobile IAB node 102 may always share by default the moving path information with donor IAB node 106 or intermediate parent IAB node 104 or may share the moving path information with donor IAB node 106 or intermediate parent IAB node 104 upon receiving an explicit reporting request from donor IAB node 106 or intermediate parent IAB node 104.

In some embodiments, a CU part of donor IAB node 106 may transmit towards an external non-3GPP entity (e.g., a UTM server) a reporting request for the moving path information of mobile IAB node 102. Donor IAB node 106 may transmit such reporting request upon receiving from a network entity (e.g., the external non-3GPP entity) an indication message indicating that mobile IAB node 102 is a moving entity (e.g., an indication that mobile IAB node 102 is a drone, a bus, or has drone/bus functionalities). After obtaining the moving path information of mobile IAB node 102, donor IAB node 106 may share the moving path information with other CUs (e.g., in case the F1 connection of mobile IAB-DU 102 is terminated at the CU of donor IAB node 106 and the RRC connection of the MT part of mobile IAB node 102 is terminated at a different CU).

The CU part of donor IAB node 106 may inquire the external non-3GPP entity about the moving path information via the core network (e.g., via the N3IWF entity) or via a direct (non-3GPP) interface used for connecting the donor CU and an external non-3GPP entity.

There may be a scenario where donor IAB node 106 receives multiple moving path information of mobile IAB node 102. For example, donor IAB node 106 may receive first moving path information of mobile IAB node 102 from the DU part of mobile IAB node 102 over the F1 interface and second moving path information of mobile IAB node 102 from the MT part of mobile IAB node 102 over the RRC connection, where the first moving path information and the second moving path information are different.

In such scenario, according to some embodiments, donor IAB node 106 may perform one or more of the following actions: (1) donor IAB node 106 may discard one of the first moving path information and the second moving path information; (2) donor IAB node 106 may merge the first moving path information and the second moving path information into one moving path information. In merging the first moving path information and the second moving path information, donor IAB node 106 may decide to perform an UNION operation or an INTERSECT operation on the first moving path information and the second moving path information.

As mentioned above, in some embodiments, mobile IAB node 102 may share its moving path information with donor IAB node 106 only upon receiving a reporting request from donor IAB node 106.

However, not all mobile IAB nodes are capable of sharing its moving path information. Therefore, in some embodiments, donor IAB node 106 or intermediate parent IAB node 104 may transmit towards mobile TAB node 102 a reporting request for the moving path information only if donor TAB node 106 or intermediate parent IAB node 104 determines that mobile TAB node 102 is capable of sharing its moving path information. If donor TAB node 106 or intermediate parent IAB node 104 determines that mobile TAB node 102 is not capable of sharing its moving path information, donor TAB node 106 or intermediate parent TAB node 104 may be refrained from transmitting such reporting request. Donor TAB node 106 or intermediate parent TAB node 104 may determine whether mobile TAB node 102 is capable of sharing its moving path information based on capability information indicating the capability of mobile TAB node 102. This capability information may be provided from mobile TAB node 102 or a different network entity.

Also, not all mobile TAB nodes may have available moving path information (i.e., the moving path information that can be provided to donor TAB node 106). Therefore, in some embodiments, mobile TAB node 102 may be configured to provide to donor TAB node 106 or intermediate parent TAB node 104 an indication indicating that mobile TAB node 102 has available moving path information prior to actually transmitting the moving path information to donor TAB node 106. In those embodiments, upon receiving such indication, donor TAB node 106 or intermediate parent TAB node 104 may transmit towards mobile TAB node 102 a reporting request for the available moving path information. This provides the benefit that donor TAB node 106 or intermediate parent TAB node 104 does not transmit the reporting request towards mobile TAB node 102 when mobile IAB node 102 does not have any available moving path information to report.

As discussed above, in some embodiments, mobile TAB node 102 transmits towards donor TAB node 106 or intermediate parent TAB node 104 the moving path information when mobile TAB node 102 establishes a connection to donor TAB node 106 or intermediate parent TAB node 104. However, there may be a scenario where mobile TAB node 102 initiates establishing a connection to donor TAB node 106 or intermediate parent TAB node 104 before obtaining any moving path information or before any moving path information becomes available. In such scenario, according to some embodiments, mobile TAB node 102 may transmit the moving path information when it becomes available (not when mobile TAB node 102 establishes a connection to donor TAB node 106 or intermediate parent TAB node 104).

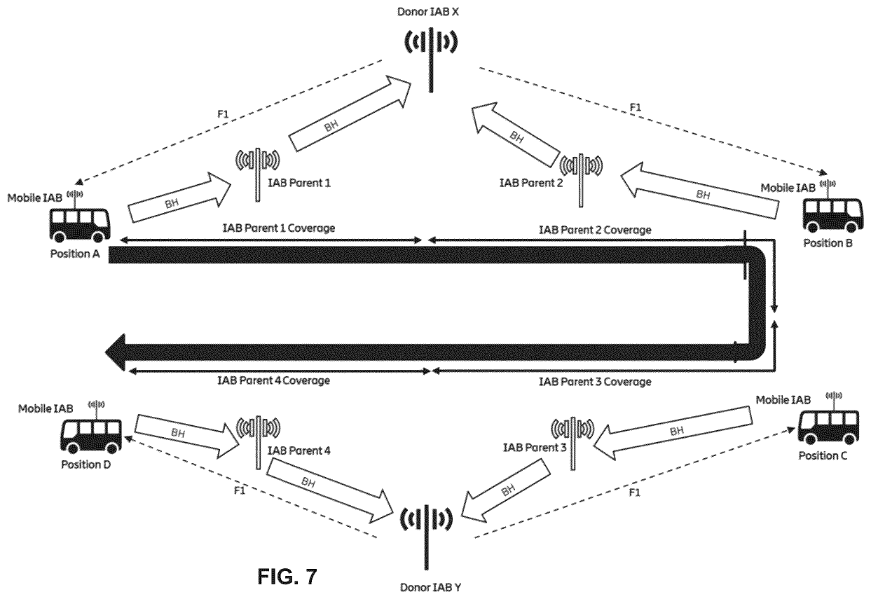

As explained with respect to FIG. 7, in some scenarios, the CU to which mobile IAB node 102 is connected may change. For example, as shown in FIG. 7, the CU to which mobile TAB node 102 is connected may change from the donor IAB X to the donor TAB Y. In such scenarios, according to some embodiments, mobile TAB node 102 may initiate transmission of its moving path information towards the new CU (e.g., the donor IAB Y). Additionally or alternatively, the old CU (a.k.a., source CU) (e.g., the donor IAB X) may transmit towards the new CU (a.k.a., target CU) (e.g., the donor TAB Y) the moving path information of mobile TAB node 102.

In some embodiments, mobile TAB node 102 may share its updated moving path information in case a previously shared moving path information becomes obsolete. For example, if mobile TAB node 102 shared its moving path information at time t1 but mobile TAB node 102 changed its moving path at time t2 which is later than time t1 (e.g., due to a change of the destination of mobile TAB node 102, or that mobile TAB node 102 needs to travel via another stop, or that mobile TAB node 102 needs to avoid an obstacle, etc.), mobile TAB node 102 may initiate sharing its updated moving path information. Mobile TAB node 102 may initiate sharing its updated moving path information by transmitting to donor TAB node 106 or intermediate parent TAB node 104 the updated moving path information or by transmitting to donor TAB node 106 or intermediate parent TAB node 104 an indication message indicating that mobile TAB node 102 has updated moving path information and waiting for donor TAB node 106 or intermediate parent TAB node 104 to transmit to mobile TAB node 102 a reporting request for the updated moving path information.

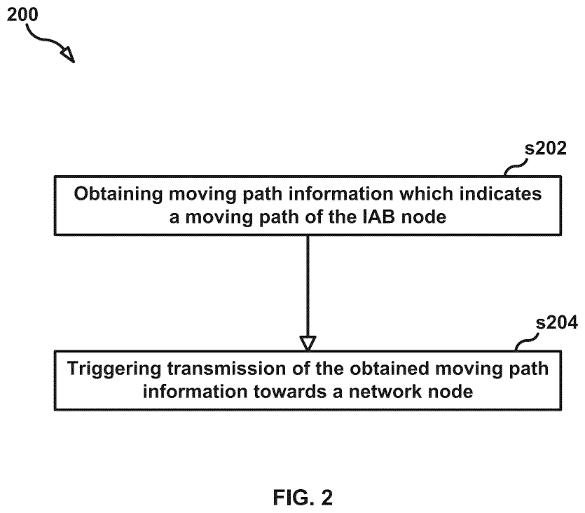

FIG. 2 shows a process 200 performed by mobile TAB node 102, according to some embodiments. Process 200 may begin with step s202. Step s202 comprises obtaining moving path information which indicates a moving path of the TAB node. Step s204 comprises triggering transmission of the obtained moving path information towards a network node, wherein the network node is either a donor TAB node or an intermediate parent TAB node.

In some embodiments, triggering transmission of the obtained moving path information comprises transmitting towards the network node an indication message indicating that the moving path information is available at the mobile TAB node or transmitting towards the network node the moving path information.

In some embodiments, transmitting towards the network node the moving path information comprises: (i) transmitting, by a distributed unit, DU, part of the mobile IAB node, an F1 application protocol, F1AP, message including the moving path information towards a centralized unit, CU, part of the donor TAB node, or (ii) transmitting, by a mobile termination, MT, part of the mobile TAB node, a radio resource control, RRC, message including the moving path information towards a DU part of the donor IAB node or the intermediate parent TAB node.

In some embodiments, the moving path information indicates one or more of; a list of one or more waypoints (i.e., 3D locations) at which the mobile TAB node is scheduled to be and/or has been; a list of one or more time stamps each indicating a timing at which the mobile IAB node is scheduled to be or has been at one of said one or more waypoints; a list of one or more time windows each indicating a time interval during which the mobile IAB node is scheduled to be or has been at one of said one or more waypoints; a list of one or more donor TAB nodes to which a distributed unit, DU, part of the mobile TAB node is scheduled to be connected and/or has been connected; a list of one or more intermediate parent TAB nodes to which a mobile termination, MT, part of the mobile TAB node is scheduled to be connected and/or has been connected; a list of one or more physical cell IDs, PCIs, identifying cells to which the mobile TAB node is scheduled to correspond or has corresponded; a list of one or more mobility-related parameters for determining the moving path of the mobile TAB node; a list of one or more arriving stations and/or one or more arriving points of interest, POIs in which the mobile TAB node is scheduled to arrive and/or has arrived; or a list of one or more time stamps each indicating a timing at which the mobile TAB node is scheduled to arrive or has arrived in one of said one or more arriving stations or one of said one or more arriving POIs.

In some embodiments, said one or more mobility-related parameters include one or more of; a set of one or more speed values each indicating a speed at which the mobile TAB node will move and/or has moved; a set of one or more acceleration values each indicating an acceleration at which the mobile TAB node will move and/or has moved; or a set of one or more angles each indicating a change of a moving direction of the mobile TAB node.

In some embodiments, transmitting the moving path information is triggered when one or more of the following conditions is satisfied: the mobile TAB node becomes connected to the network node, the mobile TAB node receives from the network node a reporting request for reporting the moving path information, the mobile IAB node reaches a coverage area of the network node, the mobile IAB node reaches a certain geographical area, a certain tracking area, TA, a certain radio access network, RAN,-based notification area, RNA, or a certain notification area, NA, or a certain geographical location, the mobile IAB node reaches a certain altitude, the mobile IAB node reaches a certain point of interest, POI, or the mobile IAB node obtains the moving path information.

In some embodiments, process 200 comprises receiving a reporting request for reporting the moving path information, wherein the reporting request was transmitted by the network node.

In some embodiments, the reporting request indicates any one or more of; how often the mobile IAB node should report the moving path information, or a height, a geographical location, a Point of Interest, POI, a radio access network, RAN,-based notification area, RNA, a tracking area, TA, and/or a notification area, NA, to be reached by the mobile IAB node in order to report the moving path information,

In some embodiments, (i) receiving the reporting request comprises receiving the reporting request at a DU part of the mobile IAB node via F1 interface, further wherein the reporting request was transmitted by a CU part of the donor IAB node, or (ii) receiving the reporting request comprises receiving the reporting request at a MT part of the mobile IAB node via radio resource control, RRC, connection, further wherein the reporting request was transmitted by a DU part of the donor IAB node or a DU part of the intermediate parent TAB node.

In some embodiments, process 200 comprises receiving reporting setup information which indicates one or more configurations of the mobile IAB node for reporting the moving path information and/or one or more conditions for the mobile IAB node to report the moving path information, wherein the reporting setup information was transmitted by the network node, and transmitting the reporting message is performed in accordance with the received reporting setup information.

In some embodiments, process 200 comprises receiving a radio resource control, RRC, message, system information, SI, and/or an F1 application protocol, F1AP, message, wherein the RRC message, the SI, and/or the F1 AP message was transmitted by the network node, and the RRC message, the SI, and/or the F1AP message includes the reporting setup information.

In some embodiments, the RRC message includes the reporting setup information, the SI and/or the F1AP message includes different reporting setup information which is different from the reporting setup information included in the RRC message, transmitting the moving path information is performed in accordance with the reporting setup information included in the RRC message, but not in accordance with said different reporting setup information included in the SI and/or the F1AP message.

In some embodiments, process 200 comprises transmitting towards the network node an indication message indicating that the mobile TAB node is capable of obtaining information about a moving path of the mobile TAB node.

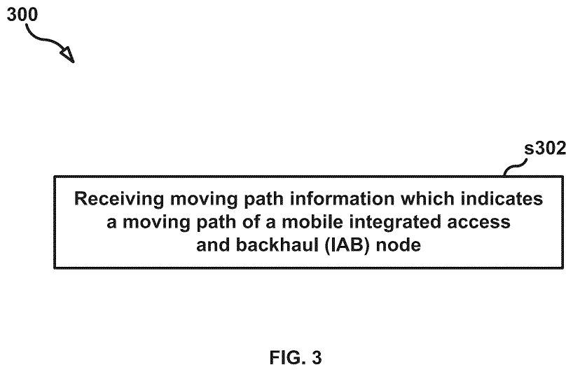

FIG. 3 shows a process 300 performed by intermediate parent IAB node 104 or donor TAB node 106, according to some embodiments. Process 300 comprises receiving moving path information which indicates a moving path of a mobile integrated access and backhaul, TAB, node. The moving path information was transmitted by the mobile TAB node or a server, and the network node is either a donor TAB node or an intermediate parent TAB node.

Process 300 comprises receiving an indication message indicating that the moving path information is available at the mobile TAB node, wherein the indication message was transmitted by the mobile TAB node.

In some embodiments, receiving the moving path information comprises: (i) receiving at a centralized unit, CU, part of the donor TAB node an F1 application protocol, F1AP, message including the moving path information, further wherein the F1AP message was transmitted by a distributed unit, DU, part of the mobile TAB node, or (ii) receiving at a DU part of the intermediate parent TAB node or a DU part of the donor TAB node a radio resource control, RRC, message including the moving path information, further wherein the RRC message was transmitted by a mobile termination, MT, part of the mobile TAB node.

In some embodiments, the moving path information indicates one or more of: a list of one or more waypoints (i.e., 3D locations) at which the mobile TAB node is scheduled to be and/or has been; a list of one or more time stamps each indicating a timing at which the mobile TAB node is scheduled to be or has been at one of said one or more waypoints; a list of one or more time windows each indicating a time interval during which the mobile TAB node is scheduled to be or has been at one of said one or more waypoints; a list of one or more donor TAB nodes to which a distributed unit, DU, part of the mobile IAB node is scheduled to be connected and/or has been connected; a list of one or more intermediate parent IAB nodes to which a mobile termination, MT, part of the mobile TAB node is scheduled to be connected and/or has been connected; a list of one or more physical cell IDs, PCIs, identifying cells to which the mobile IAB node is scheduled to correspond or has corresponded; a list of one or more mobility-related parameters for determining the moving path of the mobile IAB node; a list of one or more arriving stations and/or one or more arriving points of interest, POIs in which the mobile TAB node is scheduled to arrive and/or has arrived; or a list of one or more time stamps each indicating a timing at which the mobile TAB node is scheduled to arrive or has arrived in one of said one or more arriving stations or one of said one or more arriving POIs.

In some embodiments, said one or more mobility-related parameters include one or more of: a set of one or more speed values each indicating a speed at which the mobile IAB node will move and/or has moved; a set of one or more acceleration values each indicating an acceleration at which the mobile TAB node will move and/or has moved; or a set of one or more angles each indicating a change of a moving direction of the mobile TAB node.

In some embodiments, the moving path information was transmitted by the mobile TAB node when one or more of the following conditions is satisfied: the mobile TAB node becomes connected to the network node, the mobile TAB node receives from the network node a reporting request for reporting the moving path information, the mobile TAB node reaches a coverage area of the network node, the mobile TAB node reaches a certain geographical area, a certain tracking area, TA, a certain radio access network, RAN,-based notification area, RNA, or a certain notification area, NA, or a certain geographical location, the mobile TAB node reaches a certain altitude, the mobile TAB node reaches a certain point of interest, POT, or the mobile TAB node obtains the moving path information.

In some embodiments, process 300 comprises transmitting towards the mobile TAB node a reporting request for reporting the moving path information.

In some embodiments, the reporting request indicates any one or more of; how often the mobile TAB node should report the moving path information, or a height, a geographical location, a Point of Interest, POI, a radio access network, RAN,-based notification area, RNA, a tracking area, TA, and/or a notification area, NA, to be reached by the mobile IAB node in order to report the moving path information.

In some embodiments, (i) transmitting the reporting request comprises a CU part of the donor IAB node transmitting the reporting request towards a DU part of the mobile IAB node via F1 interface, or (ii) transmitting the reporting request comprises a DU part of the donor IAB node or a DU part of the intermediate parent IAB node transmitting the reporting request towards a MT part of the mobile IAB node via radio resource control, RRC, connection.

In some embodiments, process 300 comprises transmitting towards the mobile IAB node reporting setup information which indicates one or more configurations of the mobile IAB node for reporting the moving path information and/or one or more conditions for the mobile IAB node to report the moving path information.

In some embodiments, process 300 comprises transmitting towards the mobile IAB node a radio resource control, RRC, message, system information, SI, and/or an F1 application protocol, F1AP, message, wherein the RRC message, the SI, and/or the F1AP message includes the reporting setup information.

In some embodiments, the RRC message includes the reporting setup information, the SI and/or the F1AP message includes different reporting setup information which is different from the reporting setup information included in the RRC message, the moving path information was transmitted by the mobile IAB node in accordance with the reporting setup information included in the RRC message, but not in accordance with said different reporting setup information included in the SI and/or the F1AP message.

In some embodiments, process 300 comprises receiving an indication message indicating that the mobile IAB node is capable of obtaining information about a moving path of the mobile IAB node, wherein the indication message was transmitted by the mobile IAB node.

In some embodiments, process 300 comprises based on receiving the indication message, transmitting towards the server a reporting request for reporting the moving path information, wherein the network node receives the moving path information as a result of transmitting the reporting request towards the server, and the moving path information was transmitted by the server.

In some embodiments, process 300 comprises after receiving the moving path information, transmitting towards the mobile IAB node and/or one or more centralized units, CUs, the received moving path information.

In some embodiments, the moving path information was transmitted by the mobile IAB node via an F1 interface, the method comprises receiving another moving path information, and said another moving path information was transmitted by the mobile IAB node via an RRC connection.

In some embodiments, process 300 comprises discarding one of the moving path information or said another moving path information or merging the moving path information and said another moving path information.

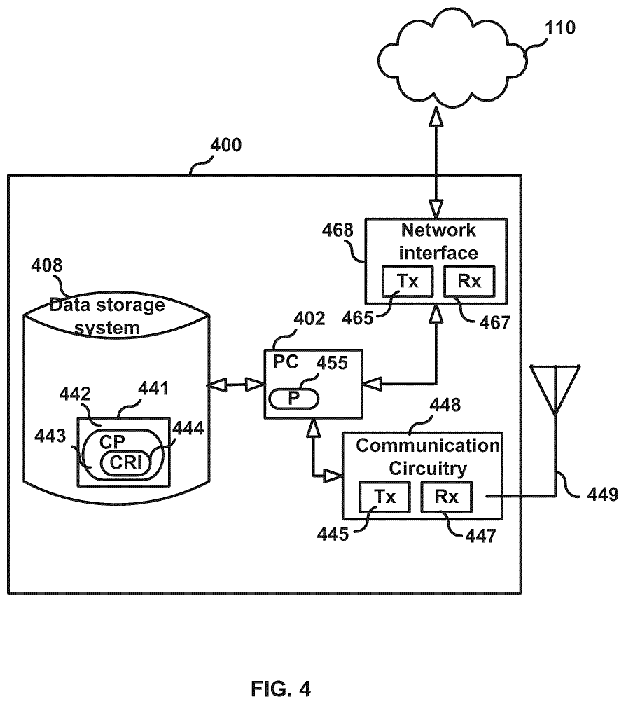

FIG. 4 is a block diagram of a network node (e.g., mobile IAB node 102, intermediate parent IAB node 104, and/or donor IAB node 106), according to some embodiments. As shown in FIG. 4, the network node may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., apparatus 400 may be a distributed computing apparatus); a network interface 468 comprising a transmitter (Tx) 465 and a receiver (Rx) 467 for enabling apparatus 400 to transmit data to and receive data from other nodes connected to a network 110 (e.g., an Internet Protocol (IP) network) to which network interface 448 is connected; communication circuitry 448, which is coupled to an antenna arrangement 449 comprising one or more antennas and which comprises a transmitter (Tx) 445 and a receiver (Rx) 447 for enabling the network node to transmit data and receive data (e.g., wirelessly transmit/receive data); and a local storage unit (a.k.a., “data storage system”) 408, which may include one or more non-volatile storage devices and/or one or more volatile storage devices. In embodiments where PC 402 includes a programmable processor, a computer program product (CPP) 441 may be provided. CPP 441 includes a computer readable medium (CRM) 442 storing a computer program (CP) 443 comprising computer readable instructions (CR1) 444. CRM 442 may be a non-transitory computer readable medium, such as, magnetic media (e.g., a hard disk), optical media, memory devices (e.g., random access memory, flash memory), and the like. In some embodiments, the CR1 444 of computer program 443 is configured such that when executed by PC 402, the CR1 causes the network node to perform steps described herein (e.g., steps described herein with reference to the flow charts). In other embodiments, the network node may be configured to perform steps described herein without the need for code. That is, for example, PC 402 may consist merely of one or more ASICs. Hence, the features of the embodiments described herein may be implemented in hardware and/or software.

### Embodiments

```
A1. In a group of embodiments, the mobile IAB, shares its mobility information with the
network (e.g., an intermediate/parent IAB node or a donor IAB node).
A2. In one embodiment according to A1, the mobile IAB, is mounted on a UAV which may
imply the mobile IAB shares capabilities of a UAV UE, like height reporting, and capability
for mobility information(or flight path plan) with the network. IN a variant, the mobile IAB
may be mounted on a train, or bus or helicopter or airplane.
A3. The IAB node shares the mobility information with the network when at least one (or a
combination) of the following criteria is fulfilled:
  Upon connecting (e.g., via the F1 interface or via the RRC connection) to a network
  node (e.g., a donor IAB node or an intermediate/parent IAB node).
  Upon changing the network node that the IAB node is connected to.
  Upon receiving a request from a network node that the mobile IAB needs to share its
  mobility information.
  When entering in the coverage of a new intermediate/parent IAB node or donor IAB
  node
    This may be detected by the CU part of the IAB node or the MT part of the IAB
    node.
  When entering in a certain geographical area/location
  When entering in a certain tracking area (TA), RAN-based notification area (RNA) or
  notification area (NA)
  When reaching a certain height
  When reaching a certain point of interest (POI)
  Upon acquiring the flight path.
  Upon acquiring an updated flight path (i.e. a path that is different from the one earlier
  transmitted).
A4 in one embodiment according to A1 to A3. The network may configured the mobile IAB
node in a dedicated RRC reconfiguration message, or broadcast in SI by donor DU, or
configure the IAB node over F1. It may also be that the configuration is limited to one of these
options. Or, that precedence is defined. For example, the donor DU may broadcast
configuration or condition on when to report and it may be specified that in case the IAB node
receives the said configuration in a RRC reconfiguration message, the RRC reconfiguration
message takes precedence. In one options, the configuration is in the measurement
configuration in IE measurement object. Further, it may be specified that when said
configuration takes place over Uu interface, it affects the reporting over Uu and similar when
configuration takes place in F1, it affect the reporting over F1. However, it may also be
specified that e.g. configuration over SI applies to both reporting over Uu and over F1.
A5. In one embodiment according to A1, the mobile IAB, shares its mobility information
within an F1AP message that is send to the donor IAB node. In this case, is the mIAB-DU
part of the mIAB that send the mobility information within an F1AP message that is directed
to the donor IAB-CU.
A6. In one embodiment according to A1, the mobile IAB, , shares its mobility information
within an RRC message that is send to the intermediate/parent IAB node or donor IAB node.
In this case, is the mIAB-MT part of the mIAB that send the mobility information within an
RRC message that is directed to the intermediate/parent IAB-DU or donor IAB-DU.
A7. In one embodiment according to A1 and A2, the intermediate/parent IAB or donor IAB
node may request explicitly to the mobile IAB to report its mobility information. In this case,
the information may be simply a one-bit indication or may include additional information such
as:
  How often the mobility information should be reported (or whether those should be
  reported only once.
  The height to be reached by the mobility IAB for reporting the mobility information
  should be reported
  A geographical location to be reached by the mobility IAB for reporting the mobility
  information should be reported
  A POI to be reached by the mobility IAB for reporting the mobility information should
  be reported
  A RNA, TA, or NA, to be reached by the mobility IAB for reporting the mobility
  information should be reported
A8. In one embodiment according to A5, the intermediate/parent IAB or donor IAB node may
send the request to the mobile IAB for reporting its mobility information over the F1 interface
(e.g., via an F1AP message) or over the RRC connection (e.g., via an RRC message that is an
RRC request message). In case the request come within an F1AP message this is sent by the
donor IAB-CU to the mobile IAB-DU and in case the request comes within an RRC message,
this is sent by the intermediate/parent IAB-DU or donor IAB-DU to the mobile IAB-MT.
A7. In one embodiment according to A1, the mobility information of the mobile IAB node,
which may be called also the flight path plan or equivalent. According to this, the content of
the flight path may include one or more of the following:
  A list of waypoints and optionally the time stamps.
  A list of donor CUs the mIAB-DU will be connected to
  A list of intermediate/parent DUs the mIAB-MT will be connected to
  List of PCIs
  List of mobility-related parameter used to calculate the flight path. This list may
  include:
    an array of speed values
    an array of acceleration values
    an array of angles that describe a change of directions
  List of arriving stations/POIs and times on when a station/POI is reached.
    This is in case the mobile IAB is used for public transportation
B1. In a group of embodiments, when the network node (e.g., the intermediate/parent IAB or
donor IAB node) receive from the mobile IAB an indication that this mobile IAB has the
capability for flight path reporting (which may be explicit indication that flight path reporting
is supported or an indication that a set of UAV functionalities is supported, including flight
path reporting), the network node sends a request to an external non-3GPP entity (e.g., a UTM
server) in order to acquire the flight path of the mobile IAB.
B2. In one embodiment according to B1, the network node (e.g., the intermediate/parent IAB
or donor IAB node), after acquiring from the non-3GPP external entity the flight path of the
mobile IAB node it share this information with the mobile IAB node but also with other CUs
(e.g., in case the F1 connection of the mobile IAB-DU is terminated at the (donor) CU and the
RRC connection of the mobile IAB-MT is terminate in a different CU). Please note that in
this case it may be the assumption is that the mobile IAB is mounted on top of a UAV but the
mobile IAB is actually not aware of what the flight path of the UAB is.
B3. In one embodiment according to B1, the network node (e.g., the intermediate/parent IAB
or donor IAB node) may send the request to the external non-3GPP entity (e.g., a UTM server),
in order to acquire the flight path of the mobile IAB, via one entity of the core network (e.g.,
the N3IWF entity) or via a a direct (non-3GPP) interface used for connecting the (donor) CU
and an external non-3GPP entity.
C1. In a group of embodiments, in case the network node (e.g., the intermediate/parent IAB
or donor IAB node) receives two flight paths, one over the F1 interface (by the mIAB-DU or
via the donor IAB-DU) and one over the RRC connection (by the intermediate/parent IAB-
MT or mIAB-MT), the network node may pursue at least one of the following actions:
  The donor IAB node discard one of the two flight paths received (e.g., the one received
  over F1 or the one received over RRC).
  The donor IAB node merge the two flight paths received into one. This means that the
  donor IAB node may decide to make a UNION or INTERSECT operation in case the
  two flight paths are different (or have some small differences) between each other's.
```

### SUMMARY OF EMBODIMENTS

A1. A method (200) performed by a mobile integrated access and backhaul, IAB, node
(102), the method comprising:
obtaining (s202) moving path information which indicates a moving path of the IAB
node; and
triggering (s204) transmission of the obtained moving path information towards a
network node (104 or 106), wherein
the network node is either a donor IAB node (106) or an intermediate parent IAB node
(104).
A2. The method of embodiment A1, wherein triggering transmission of the obtained
moving path information comprises transmitting towards the network node an indication
message indicating that the moving path information is available at the mobile IAB node or
transmitting towards the network node the moving path information.
A3. The method of embodiment A2, wherein transmitting towards the network node
the moving path information comprises:
(i) transmitting, by a distributed unit, DU, part of the mobile IAB node, an F1
application protocol, F1AP, message including the moving path information towards a
centralized unit, CU, part of the donor IAB node, or
(ii) transmitting, by a mobile termination, MT, part of the mobile IAB node, a radio
resource control, RRC, message including the moving path information towards a DU part of
the donor IAB node or the intermediate parent IAB node.
A4. The method of any one of embodiments A1-A3, wherein the moving path
information indicates one or more of:
a list of one or more waypoints (i.e., 3D locations) at which the mobile IAB node is
scheduled to be and/or has been;
a list of one or more time stamps each indicating a timing at which the mobile IAB
node is scheduled to be or has been at one of said one or more waypoints;
a list of one or more time windows each indicating a time interval during which the
mobile IAB node is scheduled to be or has been at one of said one or more waypoints;
a list of one or more donor IAB nodes to which a distributed unit, DU, part of the
mobile IAB node is scheduled to be connected and/or has been connected;
a list of one or more intermediate parent IAB nodes to which a mobile termination,
MT, part of the mobile IAB node is scheduled to be connected and/or has been connected;
a list of one or more physical cell IDs, PCIs, identifying cells to which the mobile IAB
node is scheduled to correspond or has corresponded;
a list of one or more mobility-related parameters for determining the moving path of
the mobile IAB node;
a list of one or more arriving stations and/or one or more arriving points of interest,
POIs in which the mobile IAB node is scheduled to arrive and/or has arrived; or
a list of one or more time stamps each indicating a timing at which the mobile IAB
node is scheduled to arrive or has arrived in one of said one or more arriving stations or one of
said one or more arriving POIs.
A5. The method of embodiment A4, wherein said one or more mobility-related
parameters include one or more of:
a set of one or more speed values each indicating a speed at which the mobile IAB
node will move and/or has moved;
a set of one or more acceleration values each indicating an acceleration at which the
mobile IAB node will move and/or has moved; or
a set of one or more angles each indicating a change of a moving direction of the
mobile IAB node.
A6. The method of any one of embodiments A2-A4, wherein transmitting the moving
path information is triggered when one or more of the following conditions is satisfied:
the mobile IAB node becomes connected to the network node,
the mobile IAB node receives from the network node a reporting request for reporting
the moving path information,
the mobile IAB node reaches a coverage area of the network node,
the mobile IAB node reaches a certain geographical area, a certain tracking area, TA, a
certain radio access network, RAN,-based notification area, RNA, or a certain notification area,
NA, or a certain geographical location,
the mobile IAB node reaches a certain altitude,
the mobile IAB node reaches a certain point of interest, POI, or
the mobile IAB node obtains the moving path information.
A7. The method of any one of embodiments A1-A6, comprising:
receiving a reporting request for reporting the moving path information, wherein the
reporting request was transmitted by the network node.
A8. The method of embodiment A7, wherein the reporting request indicates any one or
more of:
how often the mobile IAB node should report the moving path information, or
a height, a geographical location, a Point of Interest, POI, a radio access network,
RAN,-based notification area, RNA, a tracking area, TA, and/or a notification area, NA, to be
reached by the mobile IAB node in order to report the moving path information,
A9. The method of embodiment A7 or A8, wherein
(i) receiving the reporting request comprises receiving the reporting request at a DU
part of the mobile IAB node via F1 interface, further wherein the reporting request was
transmitted by a CU part of the donor IAB node, or
(ii) receiving the reporting request comprises receiving the reporting request at a MT
part of the mobile IAB node via radio resource control, RRC, connection, further wherein the
reporting request was transmitted by a DU part of the donor IAB node or a DU part of the
intermediate parent IAB node.
A10. The method of any one of embodiments A2-A9, comprising:
receiving reporting setup information which indicates one or more configurations of
the mobile IAB node for reporting the moving path information and/or one or more conditions
for the mobile IAB node to report the moving path information, wherein
the reporting setup information was transmitted by the network node, and
transmitting the reporting message is performed in accordance with the received
reporting setup information.
A11. The method of embodiment A10, comprising:
receiving a radio resource control, RRC, message, system information, SI, and/or an F1
application protocol, F1AP, message, wherein
the RRC message, the SI, and/or the F1AP message was transmitted by the network
node, and
the RRC message, the SI, and/or the F1AP message includes the reporting setup
information.
A12. The method of embodiment A11, wherein
the RRC message includes the reporting setup information,
the SI and/or the F1AP message includes different reporting setup information which is
different from the reporting setup information included in the RRC message,
transmitting the moving path information is performed in accordance with the
reporting setup information included in the RRC message, but not in accordance with said
different reporting setup information included in the SI and/or the F1AP message.
A13. The method of any one of embodiments A1-A12, comprising:
transmitting towards the network node an indication message indicating that the mobile
IAB node is capable of obtaining information about a moving path of the mobile IAB node.
B1. A method (300) performed by a network node (104 or 106), the method
comprising:
receiving (s302) moving path information which indicates a moving path of a mobile
integrated access and backhaul, IAB, node (102), wherein
the moving path information was transmitted by the mobile IAB node (102) or a
server, and
the network node is either a donor IAB node (106) or an intermediate parent IAB node
(104).
B2. The method of embodiment B1, comprising:
receiving an indication message indicating that the moving path information is
available at the mobile IAB node, wherein
the indication message was transmitted by the mobile IAB node.
B3. The method of embodiment B1 or B2, wherein receiving the moving path
information comprises:
(i) receiving at a centralized unit, CU, part of the donor IAB node an F1 application
protocol, F1AP, message including the moving path information, further wherein the F1AP
message was transmitted by a distributed unit, DU, part of the mobile IAB node, or
(ii) receiving at a DU part of the intermediate parent IAB node or a DU part of the
donor IAB node a radio resource control, RRC, message including the moving path
information, further wherein the RRC message was transmitted by a mobile termination, MT,
part of the mobile IAB node.
B4. The method of any one of embodiments B1-B3, wherein the moving path
information indicates one or more of:
a list of one or more waypoints (i.e., 3D locations) at which the mobile IAB node is
scheduled to be and/or has been;
a list of one or more time stamps each indicating a timing at which the mobile IAB
node is scheduled to be or has been at one of said one or more waypoints;
a list of one or more time windows each indicating a time interval during which the
mobile IAB node is scheduled to be or has been at one of said one or more waypoints;
a list of one or more donor IAB nodes to which a distributed unit, DU, part of the
mobile IAB node is scheduled to be connected and/or has been connected;
a list of one or more intermediate parent IAB nodes to which a mobile termination,
MT, part of the mobile IAB node is scheduled to be connected and/or has been connected;
a list of one or more physical cell IDs, PCIs, identifying cells to which the mobile IAB
node is scheduled to correspond or has corresponded;
a list of one or more mobility-related parameters for determining the moving path of
the mobile IAB node;
a list of one or more arriving stations and/or one or more arriving points of interest,
POIs in which the mobile IAB node is scheduled to arrive and/or has arrived; or
a list of one or more time stamps each indicating a timing at which the mobile IAB
node is scheduled to arrive or has arrived in one of said one or more arriving stations or one of
said one or more arriving POIs.
B5. The method of embodiment B4, wherein said one or more mobility-related
parameters include one or more of:
a set of one or more speed values each indicating a speed at which the mobile IAB
node will move and/or has moved;
a set of one or more acceleration values each indicating an acceleration at which the
mobile IAB node will move and/or has moved; or
a set of one or more angles each indicating a change of a moving direction of the
mobile IAB node.
B6. The method of any one of embodiments B2-B4, wherein the moving path
information was transmitted by the mobile IAB node when one or more of the following
conditions is satisfied:
the mobile IAB node becomes connected to the network node,
the mobile IAB node receives from the network node a reporting request for reporting
the moving path information,
the mobile IAB node reaches a coverage area of the network node,
the mobile IAB node reaches a certain geographical area, a certain tracking area, TA, a
certain radio access network, RAN,-based notification area, RNA, or a certain notification area,
NA, or a certain geographical location,
the mobile IAB node reaches a certain altitude,
the mobile IAB node reaches a certain point of interest, POI, or
the mobile IAB node obtains the moving path information.
B7. The method of any one of embodiments B1-B6, comprising:
transmitting towards the mobile IAB node a reporting request for reporting the moving
path information.
B8. The method of embodiment B7, wherein the reporting request indicates any one or
more of:
how often the mobile IAB node should report the moving path information, or
a height, a geographical location, a Point of Interest, POI, a radio access network,
RAN,-based notification area, RNA, a tracking area, TA, and/or a notification area, NA, to be
reached by the mobile IAB node in order to report the moving path information.
B9. The method of embodiment B7 or B8, wherein
(i) transmitting the reporting request comprises a CU part of the donor IAB node
transmitting the reporting request towards a DU part of the mobile IAB node via F1 interface,
or
(ii) transmitting the reporting request comprises a DU part of the donor IAB node or a
DU part of the intermediate parent IAB node transmitting the reporting request towards a MT
part of the mobile IAB node via radio resource control, RRC, connection.
B10. The method of any one of embodiments B1-B9, comprising:
transmitting towards the mobile IAB node reporting setup information which indicates
one or more configurations of the mobile IAB node for reporting the moving path information
and/or one or more conditions for the mobile IAB node to report the moving path information.
B11. The method of embodiment B10, comprising:
transmitting towards the mobile IAB node a radio resource control, RRC, message,
system information, SI, and/or an F1 application protocol, F1AP, message, wherein
the RRC message, the SI, and/or the F1AP message includes the reporting setup
information.
B12. The method of embodiment B11, wherein
the RRC message includes the reporting setup information,
the SI and/or the F1AP message includes different reporting setup information which is
different from the reporting setup information included in the RRC message,
the moving path information was transmitted by the mobile IAB node in accordance
with the reporting setup information included in the RRC message, but not in accordance with
said different reporting setup information included in the SI and/or the F1AP message.
B13. The method of any one of embodiments B1-B12, comprising:
receiving an indication message indicating that the mobile IAB node is capable of
obtaining information about a moving path of the mobile IAB node, wherein
the indication message was transmitted by the mobile IAB node.
B14. The method of embodiment B13, comprising:
based on receiving the indication message, transmitting towards the server a reporting
request for reporting the moving path information, wherein
the network node receives the moving path information as a result of transmitting the
reporting request towards the server, and
the moving path information was transmitted by the server.
B15. The method of embodiment B14, comprising:
after receiving the moving path information, transmitting towards the mobile IAB node
and/or one or more centralized units, CUs, the received moving path information.
B16. The method of any one of embodiments B1-B15, wherein
the moving path information was transmitted by the mobile IAB node via an F1
interface,
the method comprises receiving another moving path information, and
said another moving path information was transmitted by the mobile IAB node via an
RRC connection.
B17. The method of embodiment B16, comprising:
discarding one of the moving path information or said another moving path
information or
merging the moving path information and said another moving path information.
C1. A computer program (443) comprising instructions (444) which when executed by
processing circuitry (402) of a mobile IAB node (102) or a network node (104 or 106) causes
the mobile IAB node or the network node to perform the method of any one of the
embodiments A1-B17.
C2. A carrier containing the computer program of embodiment C1, wherein the carrier
is one of an electronic signal, an optical signal, a radio signal, and a computer readable storage
medium (442).
D1. A mobile integrated access and backhaul, IAB, node (102), the mobile IAB node
being configured to:
obtain (s202) moving path information which indicates a moving path of the IAB node;
and
trigger (s204) transmission of the obtained moving path information towards a network
node (104 or 106), wherein
the network node is either a donor IAB node (106) or an intermediate parent IAB node
(104).
D2. The mobile IAB node of embodiment D1, wherein the mobile IAB node is
configured to perform the method of any one of embodiments A2-A13.
E1. A network node (104 or 106), the network node being configured to:
receive (s302) moving path information which indicates a moving path of a mobile
integrated access and backhaul, IAB, node (102), wherein
the moving path information was transmitted by the mobile IAB node (102) or a
server, and
the network node is either a donor IAB node (106) or an intermediate parent IAB node
(104).
E2. The network node of embodiment E1, wherein the network node is configured to
perform the method of any one of embodiments B2-B17.
F1. An apparatus (400) comprising:
a processing circuitry (402); and
a memory (441), said memory containing instructions executable by said processing
circuitry, whereby the apparatus is operative to perform the method of any one of
embodiments A1-B17.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting a message “to” or “toward” an intended recipient encompasses transmitting the message directly to the intended recipient or transmitting the message indirectly to the intended recipient (i.e., one or more other nodes are used to relay the message from the source node to the intended recipient). Likewise, as used herein receiving a message “from” a sender encompasses receiving the message directly from the sender or indirectly from the sender (i.e., one or more nodes are used to relay the message from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

Abbreviations

| | |
|---|---|
| AMF | Access and Mobility Management Function |
| CN | Core network |
| D/A | Detection and avoidance |
| DCI | Downlink control information |
| DL | Downlink |
| DRX | Discontinuous reception |
| ID | Identifier |
| L1 | Layer 1 (physical layer) |
| LTE | Long Term Evolution |
| MAC | Medium Access Control |
| MAC CE | MAC control element |
| MDT | Minimization of Drive Tests |
| NAS | Non-Access Stratum |
| NR | New Radio |
| NW | Network |
| RRC | Radio Resource Control |
| RSRP | Reference signal received power |
| RSRQ | Reference signal received quality |
| RSSI | Received Signal Strength Indicator |
| RS-SINR | Reference signal SINR |
| RX | Receive |
| SINR | Signal-to-Interference-plus-Noise Ratio |
| SL | Sidelink |
| SON | Self-organizing network |
| SPS | Semi-persistent scheduling |
| TX | Transmit |
| UAV | Unmanned aerial vehicle |
| UAS | Unmanned aerial system/Unmanned aircraft system |
| UC | Use case |
| UE | User equipment |
| UL | Uplink |
| V2V | Vehicle-to-vehicle communication |
| V2X | Vehicle-to-anything communication |

### REFERENCES

[1] TS 36.300 Section “23.17.5 Flight path information reporting”
V17.1.0 19.7.2022
[2] TS 36.331 V17.1.0 20.7.2022
[2] RP-123600, New WID on NR support for UAV (Uncrewed Aerial
Vehicles), RAN#94, December 2021

1. A method performed by a mobile integrated access and backhaul, IAB, node, the method comprising:
obtaining moving path information which indicates a moving path of the IAB node; and
triggering transmission of the obtained moving path information towards a network node, wherein
the network node is either a donor IAB node or an intermediate parent IAB node.

2. The method of claim 1, wherein triggering transmission of the obtained moving path information comprises transmitting towards the network node an indication message indicating that the moving path information is available at the mobile IAB node or transmitting towards the network node the moving path information.

3. The method of claim 2, wherein transmitting towards the network node the moving path information comprises:
(i) transmitting, by a distributed unit, DU, part of the mobile IAB node, an F1 application protocol, F1AP, message including the moving path information towards a centralized unit, CU, part of the donor IAB node, or
(ii) transmitting, by a mobile termination, MT, part of the mobile IAB node, a radio resource control, RRC, message including the moving path information towards a DU part of the donor IAB node or the intermediate parent IAB node.

4. The method of claim 1, wherein the moving path information indicates one or more of:
a list of one or more waypoints (i.e., 3D locations) at which the mobile IAB node is scheduled to be and/or has been;
a list of one or more time stamps each indicating a timing at which the mobile IAB node is scheduled to be or has been at one of said one or more waypoints;
a list of one or more time windows each indicating a time interval during which the mobile IAB node is scheduled to be or has been at one of said one or more waypoints;
a list of one or more donor IAB nodes to which a distributed unit, DU, part of the mobile IAB node is scheduled to be connected and/or has been connected;
a list of one or more intermediate parent IAB nodes to which a mobile termination, MT, part of the mobile IAB node is scheduled to be connected and/or has been connected;
a list of one or more physical cell IDs, PCIs, identifying cells to which the mobile IAB node is scheduled to correspond or has corresponded;
a list of one or more mobility-related parameters for determining the moving path of the mobile IAB node;
a list of one or more arriving stations and/or one or more arriving points of interest, POIs in which the mobile IAB node is scheduled to arrive and/or has arrived; or
a list of one or more time stamps each indicating a timing at which the mobile IAB node is scheduled to arrive or has arrived in one of said one or more arriving stations or one of said one or more arriving POIs.

5. The method of claim 4, wherein said one or more mobility-related parameters include one or more of:
a set of one or more speed values each indicating a speed at which the mobile IAB node will move and/or has moved;
a set of one or more acceleration values each indicating an acceleration at which the mobile IAB node will move and/or has moved; or
a set of one or more angles each indicating a change of a moving direction of the mobile IAB node.

6. The method of claim 2, wherein transmitting the moving path information is triggered when one or more of the following conditions is satisfied:
the mobile IAB node becomes connected to the network node,
the mobile IAB node receives from the network node a reporting request for reporting the moving path information,
the mobile IAB node reaches a coverage area of the network node,
the mobile IAB node reaches a certain geographical area, a certain tracking area, TA, a certain radio access network, RAN,-based notification area, RNA, or a certain notification area, NA, or a certain geographical location,
the mobile IAB node reaches a certain altitude,
the mobile IAB node reaches a certain point of interest, POI, or
the mobile IAB node obtains the moving path information.

7.-9. (canceled)

10. The method of claim 2, comprising:
receiving, from the network node, reporting setup information which indicates one or more configurations of the mobile IAB node for reporting the moving path information and/or one or more conditions for the mobile IAB node to report the moving path information, wherein
transmitting the reporting message is performed in accordance with the received reporting setup information.

11.-13. (canceled)

14. A method performed by a network node, the method comprising:
receiving moving path information which indicates a moving path of a mobile integrated access and backhaul, IAB, node, wherein
the moving path information was transmitted by the mobile IAB node or a server, and
the network node is either a donor IAB node or an intermediate parent IAB node.

15. The method of claim 14, comprising:
receiving from the mobile IAM node an indication message indicating that the moving path information is available at the mobile IAB node.

16. The method of claim 14, wherein receiving the moving path information comprises:
(i) receiving at a centralized unit, CU, part of the donor IAB node an F1 application protocol, F1AP, message including the moving path information, further wherein the F1AP message was transmitted by a distributed unit, DU, part of the mobile IAB node, or
(ii) receiving at a DU part of the intermediate parent IAB node or a DU part of the donor IAB node a radio resource control, RRC, message including the moving path information, further wherein the RRC message was transmitted by a mobile termination, MT, part of the mobile IAB node.

17.-19. (canceled)

20. The method of claim 14, comprising:
transmitting towards the mobile IAB node a reporting request for reporting the moving path information.

21. The method of claim 20, wherein the reporting request indicates any one or more of:
how often the mobile IAB node should report the moving path information, or
a height, a geographical location, a Point of Interest, POI, a radio access network, RAN,-based notification area, RNA, a tracking area, TA, and/or a notification area, NA, to be reached by the mobile IAB node in order to report the moving path information.

22. The method of claim 20, wherein
(i) transmitting the reporting request comprises a CU part of the donor IAB node transmitting the reporting request towards a DU part of the mobile IAB node via F1 interface, or
(ii) transmitting the reporting request comprises a DU part of the donor IAB node or a DU part of the intermediate parent IAB node transmitting the reporting request towards a MT part of the mobile IAB node via radio resource control, RRC, connection.

23. The method of claim 14, comprising:
transmitting towards the mobile IAB node reporting setup information which indicates one or more configurations of the mobile IAB node for reporting the moving path information and/or one or more conditions for the mobile IAB node to report the moving path information.

24. The method of claim 23, comprising:
transmitting towards the mobile IAB node a radio resource control, RRC, message, system information, SI, and/or an F1 application protocol, F1AP, message, wherein
the RRC message, the SI, and/or the F1AP message includes the reporting setup information.

25. The method of claim 24, wherein
the RRC message includes the reporting setup information,
the SI and/or the F1AP message includes different reporting setup information which is different from the reporting setup information included in the RRC message,
the moving path information was transmitted by the mobile IAB node in accordance with the reporting setup information included in the RRC message, but not in accordance with said different reporting setup information included in the SI and/or the F1AP message.

26. (canceled)

27. The method of claim 14, comprising:
receiving from the mobile IAB node an indication message indicating that the mobile IAB node is capable of obtaining information about a moving path of the mobile IAB node
based on receiving the indication message, transmitting towards the server a reporting request for reporting the moving path information, wherein
the network node receives the moving path information as a result of transmitting the reporting request towards the server, and
the moving path information was transmitted by the server.

28. The method of claim 27, comprising:
after receiving the moving path information, transmitting towards the mobile IAB node and/or one or more centralized units, CUs, the received moving path information.

29. The method of claim 14, wherein
the moving path information was transmitted by the mobile IAB node via an F1 interface,
the method comprises receiving another moving path information, and
said another moving path information was transmitted by the mobile IAB node via an RRC connection.

30. The method of claim 29, comprising:
discarding one of the moving path information or said another moving path information or
merging the moving path information and said another moving path information.

31.-32. (canceled)

33. A mobile integrated access and backhaul, IAB, node, the mobile IAB node being configured to:
obtain moving path information which indicates a moving path of the IAB node; and
trigger transmission of the obtained moving path information towards a network node, wherein
the network node is either a donor IAB node or an intermediate parent IAB node.

34. (canceled)

35. A network node, the network node being configured to:
receive moving path information which indicates a moving path of a mobile integrated access and backhaul, IAB, node, wherein
the moving path information was transmitted by the mobile IAB node or a server, and
the network node is either a donor IAB node (106) or an intermediate parent IAB node.

36.-37. (canceled)
